(19) United States
(12) Patent Application Publication
(10) Pub. No.: US 2008/0068979 A1
(43) Pub. Date: Mar. 20, 2008

(54) ADAPTIVE AND PREEMPTIVE SCHEDULING OF TRANSMISSIONS

(75) Inventors: Eugene Visotsky, Buffalo Grove, IL (US); Roger L. Peterson, Inverness, IL (US)

Correspondence Address: MOTOROLA, INC., 1303 EAST ALGONQUIN ROAD, IL01/3RD, SCHAUMBURG, IL, 60196, US

(73) Assignee: MOTOROLA, INC., Schaumburg, IL (US)

(21) Appl. No.: 11/531,939

(22) Filed: Sep. 14, 2006

(51) Int. Cl. H04J 11/00

(52) U.S. Cl. 370/208

(57) ABSTRACT

A method and apparatus for adaptive and preemptive scheduling of transmissions is provided that reduces the end-to-end delay for ARQ transmissions in centrally controlled multi-hop communication systems. During operation, a base station provisions resources for possible future ARQ retransmissions in advance, thereby obviating the need to wait for allocations from the base station between transmission attempts on ‘remote’ hops. More specifically, a base station scheduler estimates the average number of transmission attempts that are likely to occur on a given hop for a given connection and preemptively allocates resources for this number of attempts. The average number of transmission attempts is estimated based on, for example, channel conditions or a recent history of transmission attempts collected and stored by the base station.

### FIELD OF THE INVENTION

The present invention relates generally to communication systems and in particular, to a method and apparatus for adaptive and preemptive scheduling of transmissions within such communication systems.

### BACKGROUND OF THE INVENTION

Digital data transmissions over wired and wireless links sometimes may be corrupted, for instance, by noise in the link or channel, by interference from other transmissions, by multipath radio propagation, by transceiver filtering, or by other signal processing degradations. Even in the absence of noise and interference, it may not be possible to correctly decode the data stream with the requisite error rates. In order to solve this problem, many current communication systems employ an automatic repeat request (ARQ) scheme for retransmission. In such systems an opportunity exists for requesting that data be retransmitted upon detection of an error. In more complex systems a type-II hybrid ARQ scheme is employed. In systems employing a type-II hybrid ARQ (HARQ) scheme a receiver combines previously received erroneous transmissions of a packet of information with a newly received transmission in an effort to successfully ascertain the true contents of the packet.

In some next-generation communication systems, a controller, or base station schedules and allocates resources (i.e. communications channels) for both the uplink and downlink transmissions. Thus, when a mobile station needs to request retransmission of data, it must notify the scheduler, and be assigned a resource, prior to any retransmission taking place. Assignments of resources typically occur with the controller sending a map of resources to all mobile units under its control.

Consider now a two-hop downlink connection, where packets are forwarded from a base station to a mobile station through an intermediate relay station. (Extension to connections involving three or more hops is possible). The timing diagram for one possible two-hop downlink HARQ protocol is depicted in FIG. 1. This figure illustrates an N-channel stop-and-wait protocol where each channel individually follows a stop-and-wait HARQ protocol and N separate channels are interlaced in order to utilize resources while individual channels await ACK/NAK responses. While the protocol is N-channel; for clarity, the time evolution of only two HARQ channels is depicted in the figure. The HARQ process on the first hop (base station-to-relay station) is identical to the downlink single-hop HARQ process. Specifically, upon obtaining an ACK from the first hop in frame k+2, base station schedules the next hop and includes this allocation in the map sent to the relay station in frame k+4. The relay station receives the map in frame k+4 and initiates the transmission on the second hop in frame k+5. For the second downlink hop (relay station-to-mobile station), the base station makes the scheduling decisions based on the per-hop ACK/NAK feedback provided to the base station by the relay station. Hence, all second-hop ACK/NAK messages received at the relay station are forwarded to the base station. Upon obtaining a NAK for the second hop, the base station either schedules another transmission attempt on that hop or drops the packet if the transmission attempt limit has been reached. Upon obtaining an ACK for the second hop, the base station assigns an outstanding MAC-PDU to the HARQ channel. The two-hop uplink HARQ process also depicted in FIG. 1 follows a similar timing diagram. Specifically, the HARQ process on the second hop (relay station-to-base station) is the same as the single-hop HARQ protocol. On the first hop (mobile station-relay station), all transmissions are scheduled at the base station in response to the ACK/NAK feedback provided to the base station by the relay station.

As is evident, the HARQ protocol as implemented in FIG. 1 results in significant end-to-end transmission delays, which could be prohibitive for real-time applications. The largest component of this delay is the waiting time on ‘remote’ hops between transmitting a packet and receiving a channel allocation from the base station for a subsequent transmission. For instance on the downlink, it takes at least three frames, including a one-frame scheduling delay at the base station, between the reception of a NAK at the relay station and its next downlink transmission attempt. Similarly on the uplink, it takes five frames between a failed transmission attempt from mobile to relay and the next transmission attempt by the mobile. Therefore, a need exists for a method and apparatus for adaptive and preemptive scheduling of transmissions that reduces the end-to-end delay experienced with the ARQ technique of FIG. 1.

### BRIEF DESCRIPTION OF THE DRAWINGS

FIG. 1 illustrates HARQ in a multi-hop environment without the invention.

FIG. 2 is a block diagram of a communication system.

FIG. 3 gives an example the proposed ARQ protocol with preemptive scheduling for uplink and downlink connections.

FIG. 4 is a more-detailed block diagram of the base station and the relay station of FIG. 2.

FIG. 5 is a flow chart showing operation of the base station of FIG. 4.

FIG. 6 is a flow chart showing operation of the relay station of FIG. 4 during transmissions to a remote unit.

FIG. 7 is a flow chart showing operation of the relay station of FIG. 4 during transmissions from a remote unit.

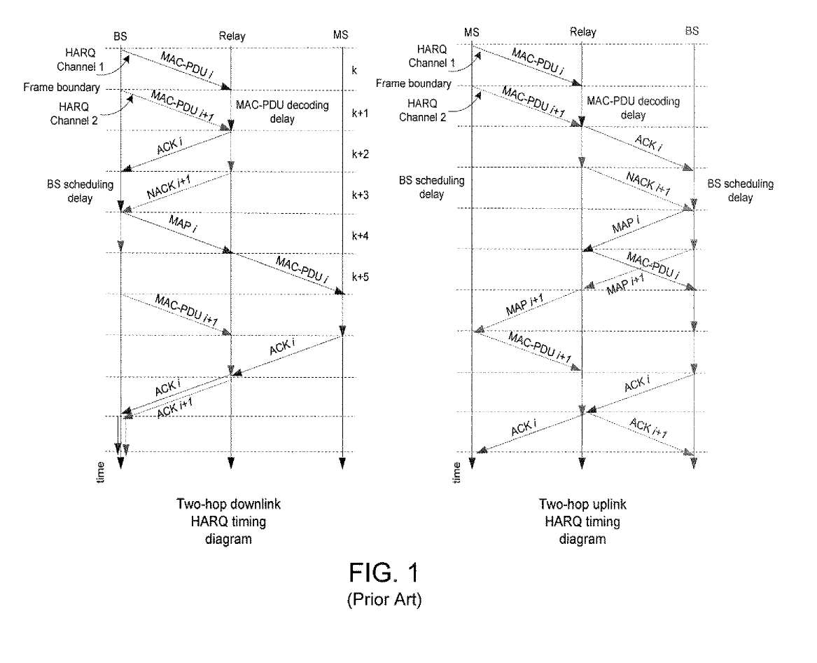

### DETAILED DESCRIPTION OF THE DRAWINGS

In order to address the above-mentioned need, a method and apparatus for adaptive and preemptive scheduling of transmissions is provided that reduces the end-to-end delay for ARQ transmissions. During operation, a base station provisions resources for possible future ARQ retransmissions in advance, thereby obviating the need to wait for allocations from the base station between transmission attempts on ‘remote’ hops. More specifically, a base station scheduler estimates the average number of transmission attempts that are likely to occur on a given hop for a given connection and preemptively allocates resources for this number of attempts. The average number of transmission attempts is estimated based on, for example, channel conditions or a recent history of transmission attempts collected and stored by the base station.

Because resources (i.e., channels and time periods) are allocated to mobile units prior to the resources actually being needed, any ARQ transmission will not need to request a channel and wait for the channels to be allocated. This greatly reduces end-to-end delay for ARQ transmissions.

The present invention encompasses a method for preemptive scheduling of transmissions. The method comprises the steps of estimating a number of transmission attempts that are likely to occur on a given link between a relay station and a remote unit, and allocating a number of future resources between the relay station and the remote unit based on the estimation, wherein the allocated resources are to be used for retransmission of data.

The present invention additionally encompasses a method comprising the steps of receiving data at a relay station to be transmitted to a remote unit and receiving information about a number of future resources between the relay station and the remote unit. The number of future resources is based on an estimated number of transmission attempts that are likely to occur on a given link between the relay station and the remote unit. The estimate of the number of transmission attempts is based upon channel quality. Data is relayed to the remote unit and, if it is determined that the data was not received by the remote unit, a future resource is utilized from the number of future resources in order to retransmit the data to the node.

The present invention additionally encompasses a method comprising the steps of receiving information on a current resource to be utilized by a remote unit in uplink transmissions, and receiving information on future resources that may be utilized by the remote unit in uplink transmissions, where a number of future resources is based on channel quality. If information is transmitted by the remote station using the current resource and a determination is made that the transmission unit was not correctly received, information is transmitted to the remote unit about a future resource to be used for uplink retransmissions and uplink retransmissions are received from the remote unit via the future resource.

The present invention additionally encompasses an apparatus comprising logic circuitry for estimating a number of transmission attempts that are likely to occur on a given link between a relay station and a remote unit and allocating a number of future resources between the relay station and the remote unit based on the estimation, wherein the allocated resources are to be used for retransmission of data.

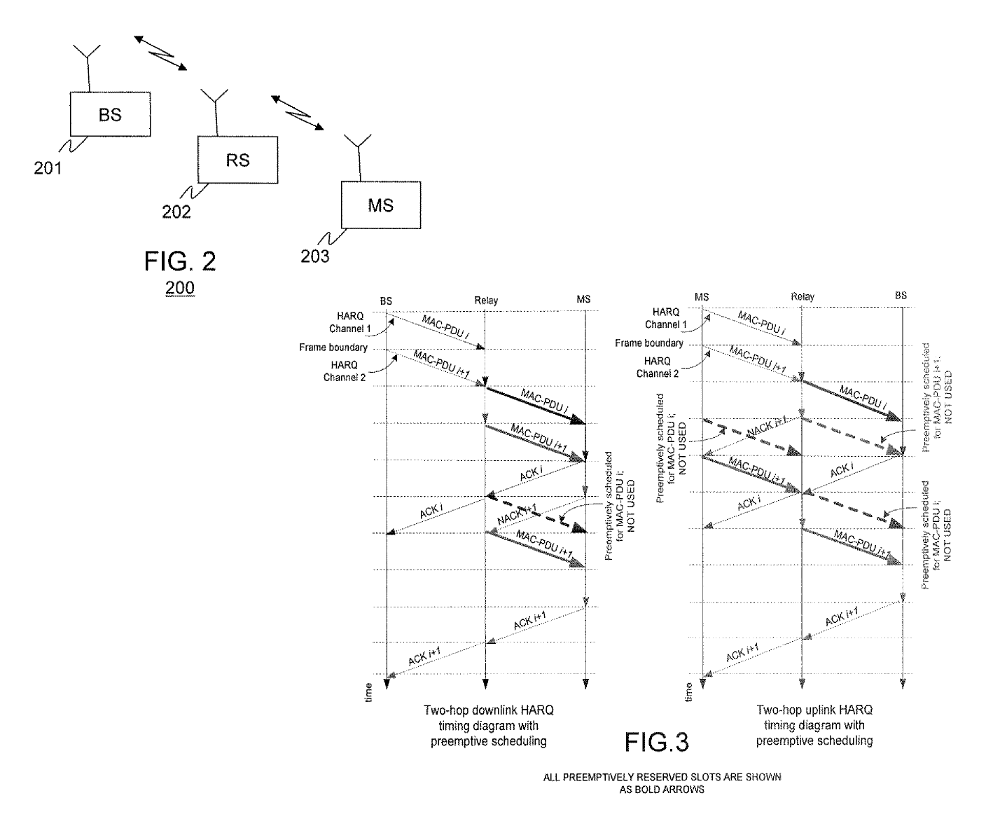

Turning now to the drawings, wherein like numerals designate like components, FIG. 2 is a block diagram of communication system 200. Communication system 200 comprises a relay-enhanced communication system as envisioned by the IEEE 802.16j standards Task Group; however one of ordinary skill in the art will recognize that other communication system protocols may be utilized.

As shown, communication system 200 comprises base station (BS) 201, relay station (RS) 202, and mobile station (MS) 203. It should be noted that mobile station 203 can be any mobile, or stationary communication device, such as but not limited to a cellular telephone, a laptop computer, . . . , etc. Additionally, while only one base station 201, relay station 202, and mobile station 203 are shown in FIG. 2, one of ordinary skill in the art will recognize that typical communication systems 200 will comprise multiple base stations 201, relay stations 202, and mobile stations 203.

During operation, base station 201 will determine a number of transmission attempts that are likely to occur on a given link (i.e., uplink and/or downlink) between a relay station and a mobile station. In the preferred embodiment of the present invention this determination is made based on channel condition such that better channel conditions results in fewer resources being reserved for future transmissions. For example, the expected number of transmission attempts could be analytically computed according to the following expression:

$${\overline{N}}_{Attempts} = 1 + {\sum }_{i = 1}^{J - 1} {P}_{i} ,$$

where J denotes the maximum number of transmission attempts performed by the ARQ protocol and Pᵢ denotes the probability of decoding error for the ith transmission attempt. The probability of decoding error can be estimated based on the signal-to-interference-plus-noise ratio (SINR) or received signal strength indication (RSSI) measurements at the receiver or based on the history of past decoding failures.

In alternate embodiments of the present invention the determination of the number of transmission attempts that are likely to occur can be based on other factors. For example, the average number of transmission attempts could be estimated based on the recent history of transmission attempts collected and stored at the MAC layer or could be semi-analytically calculated based on the channel quality feedback obtained at base station 201.

Once the number of transmission attempts is estimated, base station 201 will determine a number of future channel resources to reserve for mobile station 203. These resources will be allocated to mobile station 203 by base station 201 transmitting a map to relay station 202, and ultimately to mobile station 203. The map may also be transmitted directly to the mobile station in some implementations where control information does not follow the same relay path as mobile station user information. Thus, the proposed algorithm adaptively varies the number of attempts that are preemptively allocated based on the current channel conditions.

Examples of the proposed ARQ protocol with preemptive scheduling for uplink and downlink connections is displayed FIG. 3. For the downlink example, it is assumed that the base-station-to-relay-station link does not require preemptive slot reservations. The second hop (relay-station-to-mobile-station) is assumed unreliable, requiring an average of two transmission attempts per MAC PDU. The algorithm then reserves two downlink slots for MAC PDU i on the second hop. This reservation is made by the scheduler at the base station and obtained at the relay station from decoding, for example, the 802.16 MAP message contained in the same frame as MAC PDU i. Note that in this example, MAC PDU i is decoded at the mobile station on the first transmission attempt and the second reserved slot will be unused, resulting in decreased throughput. Conversely, in this example, MAC PDU i+1 is decoded after two transmission attempts thereby fully utilizing both reserved slots. Note that by utilizing a reserved slot, the relay station immediately performs the second transmission attempt for MAC PDU i+1 without sending ACK/NAK feedback to the base station. If more transmission attempts are required than preemptively reserved, the algorithm defaults to the basic two-hop HARQ protocol for transmissions that are not preemptively scheduled. A similar preemptive scheduling algorithm is performed on the uplink in FIG. 3. In this case, an additional slot is reserved on the first hop, and two transmissions slots are reserved on the second hop.

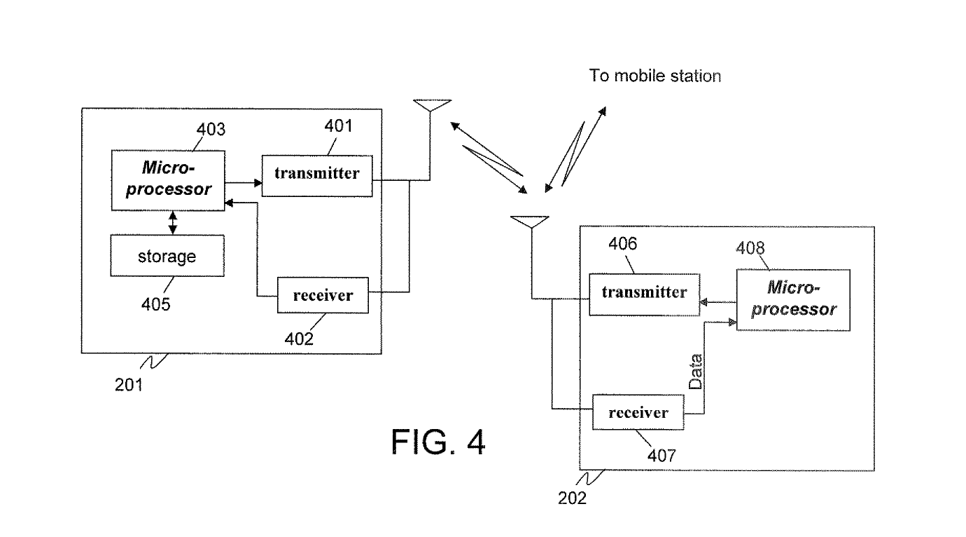

FIG. 4 is a more-detailed block diagram of the base station and the relay station of FIG. 2. As shown, both base 201 and relay station 202 comprise logic circuitry 403 and 408 (microprocessors 403 and 408), receive circuitry 402 and 407, and transmit circuitry 401 and 406. Logic circuitry 403 and 408 preferably comprises a microprocessor controller, such as, but not limited to a Freescale PowerPC microprocessor. In the preferred embodiment of the present invention logic circuitry 403 and 408 serve as means for controlling base station 201 and relay station 202, respectively, and as means for analyzing message content to determine any actions needed. Additionally, logic circuitry 403 serves as a controller for allocating channel resources within communication system 200.

Receive and transmit circuitry are common circuitry known in the art for communication utilizing a well known communication protocol, and serve as means for transmitting and receiving messages. For example, receivers 402 and 407, and transmitters 401 and 406 are well known transmitters that utilize the IEEE 802.16j communication system protocol. Other possible transmitters and receivers include, but are not limited to transceivers utilizing IEEE 802.20 or the 3GPP LTE communication protocols.

As described above, in 802.16j one possibility is to have base station 201 allocate resources for all nodes within a cell. With this in mind, relay station 202 will have to be allocated a channel/time resource by base station 201 in order to retransmit any data packet to a mobile station. When the mobile station does not receive a packet, it sends a NAK to relay station 202, which in the prior art is forwarded to base station 201. The base station then allocates a resource between the relay station and the mobile station for the retransmission. This takes several frames to complete. In order to address this issue, base station 201 will allocate a time/frequency resource for retransmitting any lost packet in advance of receiving a NAK. This will be done based on, for example, the channel condition, the number of NAKs being received, FER, . . . etc.

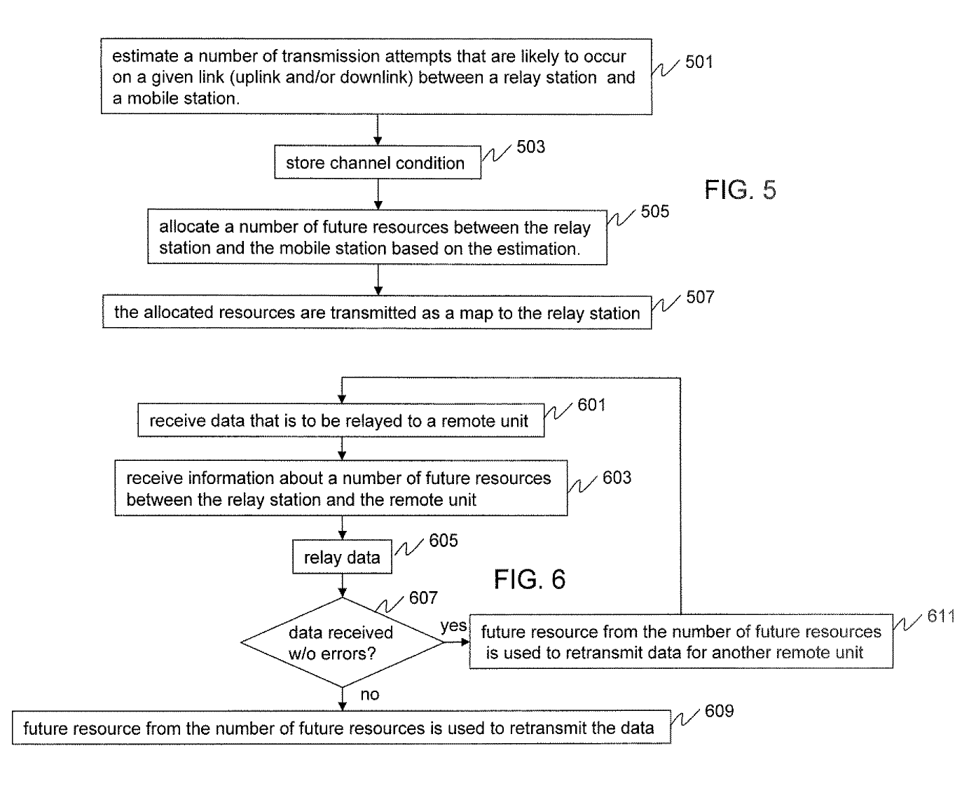

FIG. 5 is a flow chart showing operation of the base station of FIG. 4. The logic flow begins at step 501 where logic circuitry 403 estimates a number of transmission attempts that are likely to occur on a given link (uplink and/or downlink) between relay station 202 and mobile station 203. As discussed above, the estimated number of transmission attempts may be based on a channel condition between the relay station and the mobile station. The channel condition may be provided by the mobile station to the base station by receiver 402 receiving base station pilot transmissions and estimating signal-to-interference-plus-noise ratio from these pilot transmissions. The channel condition is stored in storage 405 (step 503).

Continuing, at step 505 logic circuitry 403 allocates a number of future resources between the relay station and the mobile station based on the estimation. As discussed, the allocated resources are to be used for future retransmission of data. In the case of communication system 200, the future resources comprises OFDM resources, however, in other types of communication systems, other resources/channels may be allocated. For example, a timeslot, a frequency, a timeslot/frequency combination, an orthogonal code, or any other type of channel may be allocated in other communication systems. Finally, at step 507, the allocated resources are transmitted (via transmitter 401) as a map to relay station 202.

It should be noted that because communication system 200 utilizes an Orthogonal Frequency Division Multiplexed (OFDM) communication system protocol, the allocated resources comprise OFDM resources (frequencies) to be used at a plurality of future time periods.

FIG. 6 is a flow chart showing operation of the relay station of FIG. 4 during transmissions to a remote unit. In the following scenario, the remote unit comprises a mobile unit; however, one of ordinary skill in the art will recognize that the remote unit may comprise a base station or other relay stations. The logic flow begins at step 601 where receiver 407 receives data that is to be relayed to a remote unit. In one embodiment, the data is received from a base station. In alternate embodiments, the data may be received from any remote unit, including other relay nodes. At step 603 receiver 407 receives information about a number of future resources between the relay station and the remote unit. As discussed, this may be part of a map transmission sent from a base station. Additionally, the number of future resources is based on an estimated number of transmission attempts that are likely to occur on a given link between the relay station and the remote unit. The estimated number of transmission attempts may be based on a channel condition between the relay station and the remote unit.

Continuing, at step 605 a transmitter 406 relays the data to the remote unit and logic circuitry 408 determines if the data was received without errors by the remote unit (607). As discussed, this determination is made based on whether an ARQ NAK or ACK was received from the remote unit. When a determination is made that the data was not correctly received by the remote unit, a future resource from the number of future resources is used to retransmit the data to the node (step 609).

It should be noted that there may be situations where the data was correctly received by the remote unit, and future resources have been allocated for the re-transmission of the data. In this situation, if logic circuitry 408 determines that the future resources will not be needed by the remote unit, the resources may be re-allocated to another (a second) remote unit (step 611) and the logic flow returns to step 601.

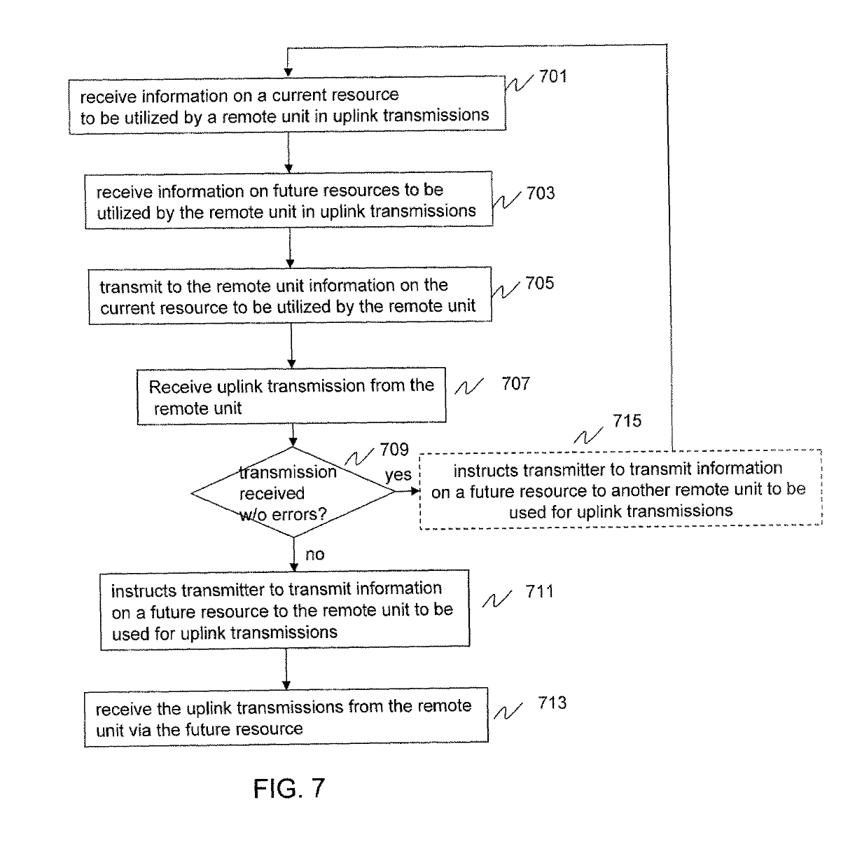

FIG. 7 is a flow chart showing operation of the relay station of FIG. 4 for transmissions received from a remote unit. The logic flow begins at step 701 where receiver 407 receives information on a current resource to be utilized by a remote unit in uplink transmissions. As discussed above, the information typically comprises a map transmission from a base station. At step 703 receiver 407 receives information on future resources to be utilized by the remote unit in uplink transmissions. As discussed, the number of future resources is based on channel quality. Transmitter 406 then transmits to the remote unit information on the current resource to be utilized by the remote unit (step 705). Receiver 407 then receives uplink transmission from the remote unit in step 707. Logic circuitry 408 then determines if the uplink transmission from the remote unit was received without errors (step 709). If transmission was received with errors, logic circuitry instructs transmitter 406 to transmit information to the remote unit about future resource to be used for uplink transmissions (step 711). At step 713, receiver 407 receives the uplink transmissions from the remote unit via the future resource. In step 709, if logic circuitry 408 determines that the transmission was received without errors, and hence future resources will not be needed by the remote unit, the resources may be re-allocated to another (a second) remote unit (step 715) and the logic flow returns to step 701. However, if at step 715, the future resources are not used for another remote unit, the logic flow simply returns to step 701.

While the invention has been particularly shown and described with reference to a particular embodiment, it will be understood by those skilled in the art that various changes in form and details may be made therein without departing from the spirit and scope of the invention. It is intended that such changes come within the scope of the following claims.

1. A method for preemptive scheduling of retransmissions, the method comprising the steps of:
estimating a number of transmission attempts that are likely to occur on a given link between a relay station and a remote unit; and
allocating a number of future resources between the relay station and the remote unit based on the estimation, wherein the allocated resources are to be used for retransmission of data.

2. The method of claim 1 wherein the step of estimating the number of transmission attempts that are likely to occur on the given link comprises the step of estimating the number of transmission attempts that are likely to occur on an uplink and/or downlink.

3. The method of claim 1 wherein the estimated number of transmission attempts is based on a channel condition between the relay station and the remote unit.

4. The method of claim 3 wherein the channel condition is provided by the remote unit.

5. The method claim 1 wherein the step of allocating the number of future resources comprises the step of allocating a plurality of OFDM resources to be used at a plurality of future time periods.

6. The method of claim 1 wherein the step of allocating the future resources comprises the step of allocating channels to be used if needed at a future time.

7. A method comprising the steps of:
receiving data at a relay station to be transmitted to a remote unit;
receiving information about a number of future resources between the relay station and the remote unit, wherein the number of future resources is based on an estimated number of transmission attempts that are likely to occur on a given link between the relay station and the remote unit;
relaying the data to the remote unit;
determining that the data was not received by the remote unit; and
utilizing a future resource from the number of future resources in order to retransmit the data to the node.

8. The method of claim 7 wherein the step of receiving data comprises the step of receiving data from a base station or a remote unit.

9. The method of claim 7 the step of receiving a number of future resources comprises the step of receiving the number of future resources from a base station.

10. The method of claim 7 wherein the remote unit comprises a base station or a remote unit.

11. The method of claim 7 wherein the estimated number of transmission attempts is based on a channel condition between the relay station and the remote unit.

12. The method claim 7 wherein the number of future resources comprises a plurality of OFDM resources to be used at a plurality of future time periods.

13. The method of claim 7 further comprising the steps of:
determining that the future resources will not be needed by the remote unit; and
re-allocating the future resources to a second remote unit.

14. A method comprising the steps of:
receiving information on a current resource to be utilized by a remote unit in uplink transmissions;
receiving information on future resources be utilized by the remote unit in uplink transmissions, wherein a number of future resources is based on channel quality;
transmitting to the remote unit, information on the current resource to be utilized by the remote unit;
determining that the uplink transmission from the remote unit was not received;
transmitting information to the remote unit about future resource unit to be used for uplink transmissions; and
receiving the uplink transmissions from the remote unit via the future resource.

15. The method of claim 14 further comprising the steps of:
determining that the future resources will not be needed by the remote unit; and
re-allocating the future resources to a second remote unit.

16. An apparatus comprising:
logic circuitry estimating a number of transmission attempts that are likely to occur on a given link between a relay station and a remote unit and allocating a number of future resources between the relay station and the remote unit based on the estimation, wherein the allocated resources are to be used for retransmission of data.

17. The apparatus of claim 16 wherein the link comprises an uplink and/or a downlink.

18. The apparatus of claim 16 wherein the estimated number of transmission attempts is based on a channel condition between the relay station and the remote unit.

19. The apparatus of claim 18 wherein the channel condition is provided by a remote unit.

20. The apparatus claim 16 wherein the number of future resources comprises OFDM resources to be used at a plurality of future time periods.
